(19) United States
(12) Patent Application Publication
(10) Pub. No.: US 2025/0244594 A1
(43) Pub. Date: Jul. 31, 2025

(54) SYSTEMS AND METHODS FOR REAL-TIME PHASE-BASED IMAGING FOR ADDITIVE MANUFACTURING

(71) Applicant: Lawrence Livermore National Security, LLC, Livermore, CA (US)

(72) Inventors: Dongping TERREL-PEREZ, Livermore, CA (US); Johanna Jesse SCHWARTZ, Livermore, CA (US)

(21) Appl. No.: 18/931,977

(22) Filed: Oct. 30, 2024

Related U.S. Application Data
(60) Provisional application No. 63/626,285, filed on Jan. 29, 2024.

(51) Int. Cl. G02B 27/10; G02B 27/28

(52) U.S. Cl. CPC G02B 27/1026; G02B 27/28

(57) ABSTRACT

The present disclosure relates to a system for monitoring polymerization of a photo-responsive resin during an additive manufacturing operation involving manufacture of a part from the photo-responsive resin. The may have an optical system for generating a beam of light, a polarizer for polarizing the beam of light to create a linearly polarized light beam, with the linearly polarized light beam forming a first un-scattered beam after passing through a portion of the photo-responsive resin having a first refractive index, and a second scattered sample beam after passing through a second portion of the photo-responsive resin having begun a polymerization process and having a second refractive index. A spatial slight modulator receives the un-scattered beam and the scattered sample beam and controllably varies a phase of one or the other to create multiple images of the photo-responsive resin. A controller subsystem receives and combines the multiple images to create a composite image having increased contrast of the photo-responsive resin.

### CROSS-REFERENCE TO RELATED APPLICATIONS

This application claims the benefit of U.S. Provisional Application No. 63/626,285, filed on Jan. 29, 2024. The disclosure of the above application is incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for additive manufacturing (AM), and more particularly to systems and methods for volumetric AM employing phase detection techniques to provide dramatically improved, high contrast images of a polymerization process occurring with photo-responsive resins of low refractive index change, and in real-time, to enable visualizing the polymerization process in real-time.

### BACKGROUND

The statements in this section merely provide background information related to the present disclosure and may not constitute prior art.

Tomographic volumetric additive manufacturing (“VAM”) has revolutionized light-driven additive manufacturing (“AM”) by concurrently printing freeform 3D objects all-at-once without layering artifacts. This ability expands the geometric freedom and material scope accessible, achieving fully printed end use objects that can be created quickly.

To ensure a successful print, in-situ monitoring systems that can visualize the structure's form and correctly control the light exposure is essential. Otherwise, objects may not be completely formed or may have resulting outgrowth, limiting use and VAM success rates. Multiple methods have been reported to visualize the VAM process. These methods rely on large refractive index change or scattering property change of resin materials upon polymerization. However, for resin materials with low refractive index change and low scattering profile change, these methods often fail with low contrast and sensitivity.

In view of the foregoing drawbacks with existing VAM systems and methods, there is a strong need for imaging systems and methods that can visualize VAM processes of low-refractive index-change materials.

### SUMMARY

This section provides a general summary of the disclosure, and is not a comprehensive disclosure of its full scope or all of its features.

In one aspect the present disclosure relates to a system for monitoring polymerization of a photo-responsive resin held in a reservoir during an additive manufacturing operation involving manufacture of a part from the photo-responsive resin. The system may include an optical system for generating a beam of light, and a polarizer for polarizing the beam of light to create a linearly polarized light beam. The linearly polarized light beam forms a first un-scattered beam after passing through a portion of the photo-responsive resin having a first refractive index, and a second scattered sample beam after passing through a second portion of the photo-responsive resin having begun a polymerization process and having a second refractive index. A spatial slight modulator may be included for receiving the first un-scattered beam and the second scattered sample beam and controllably varying a phase of one of the un-scattered beam or the scattered sample beam to create multiple images of the photo-responsive resin. The multiple images represent a phase shift between the first un-scattered beam and the second scattered sample beam. A controller subsystem may be included for receiving and combining the multiple images to create a composite image having increased contrast of the photo-responsive resin.

In another aspect the present disclosure relates to a system for monitoring polymerization of a photo-responsive resin held in a reservoir during an additive manufacturing operation involving manufacture of a part from the photo-responsive resin. The system may include a spatial light modulator, a camera, a laser for generating a beam of light, and a projector for projecting at least one of a 2D or 3D image into the resin held within the reservoir, the 2D or 3D image representing the part. A polarizer may also be included for polarizing the beam of light to create a linearly polarized light beam. The linearly polarized light beam forms a first un-scattered beam after passing through a portion of the photo-responsive resin having a first refractive index. The light beam also forms a second scattered sample beam after passing through a second portion of the photo-responsive resin which has begun a polymerization process, and has a second refractive index. A beam splitter may also be included for passing a first portion of the first un-scattered beam and a first portion of the scattered sample beam to the spatial light modulator, and a second portion of the first un-scattered beam and a second portion of the second scattered sample beam to the camera for recording as images representing an interference pattern. The spatial slight modulator receives the first portion of the first un-scattered beam and the first portion of the second scattered sample beam and controllably varies a phase of one of the un-scattered beam or the scattered sample beam to create at least one image of the photo-responsive resin. The at least one image represents a phase shift between the first un-scattered beam and the second scattered sample beam. Image information may then be transmitted corresponding to the phase shift back through the beam splitter to the camera. A controller subsystem may also be included for receiving and combining the second portion of the un-scattered beam and the image information to create a composite image having increased contrast of the photo-responsive resin.

In still another aspect the present disclosure relates to a method for monitoring polymerization of a photo-responsive resin held in a reservoir during an additive manufacturing operation involving manufacture of a part from the photo-responsive resin. The method may include generating a beam of light, and then using a polarizer to polarize the beam of light to create a linearly polarized light beam. The linearly polarized light beam forms a first un-scattered beam after passing through a portion of the photo-responsive resin having a first refractive index. The light beam also forms a second scattered sample beam after passing through a second portion of the photo-responsive resin having begun a polymerization process, and has a second refractive index. The first un-scattered beam and the second scattered sample beam are used to controllably vary a phase of one of the un-scattered beam or the scattered sample beam to create multiple images of the photo-responsive resin. The images represent a phase shift between the first un-scattered beam and the second scattered sample beam. The multiple images are combined to create a composite image having increased contrast of the photo-responsive resin.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one embodiment of a system in accordance with the present disclosure;

FIGS. 2a, 2a1, 2b,2b1, 20,2c1 and 2d,2d1 are comparisons of the differences in visible detail apparent when viewing just a shadowgraph (FIG. 2a1), versus phase contrast images with different phase shifts between the un-scattered reference beam and scattered sample beam of FIG. 1;

FIG. 2e shows a quantitative phase image (QPI) reconstructed from the four images with different phase shifts used in FIGS. 2a-2d, illustrating the dramatically improved detail visible in the QPI compared with the shadowgraph FIG. 2a1;

FIG. 3 is a high level diagram showing the phase information of the sample can be retrieved from measurements of the interference pattern (hologram) between an un-scattered reference beam and a scattered sample beam. The phase information provides high contrast visualization of the polymerization process;

FIGS. 4a-4c illustrate a measured shadowgraph (FIG. 4a), a measured phase contrast image (FIG. 4b), and a reconstructed QPI image (FIG. 4c) during the real-time visualization of a VAM process for a silicone resin material having a small refractive index change, and wherein the figures illustrate the significantly enhanced resolution and detail in the measured phase contrast image (FIG. 4b) and the QPI image (FIG. 4c) over the shadowgraph (FIG. 4a);

Referring to FIG. 5, a high level flowchart 200 is shown illustrating various operations that may be performed in creating a QPI image using the system 10.

### DETAILED DESCRIPTION

Example embodiments will now be described more fully with reference to the accompanying drawings.

The present disclosure relates to new systems and methods for VAM. In various embodiments and methods, the present disclosure involves implementing imaging methods which exploit phase change of imaging light induced by resin materials to enable visualizing the VAM process.

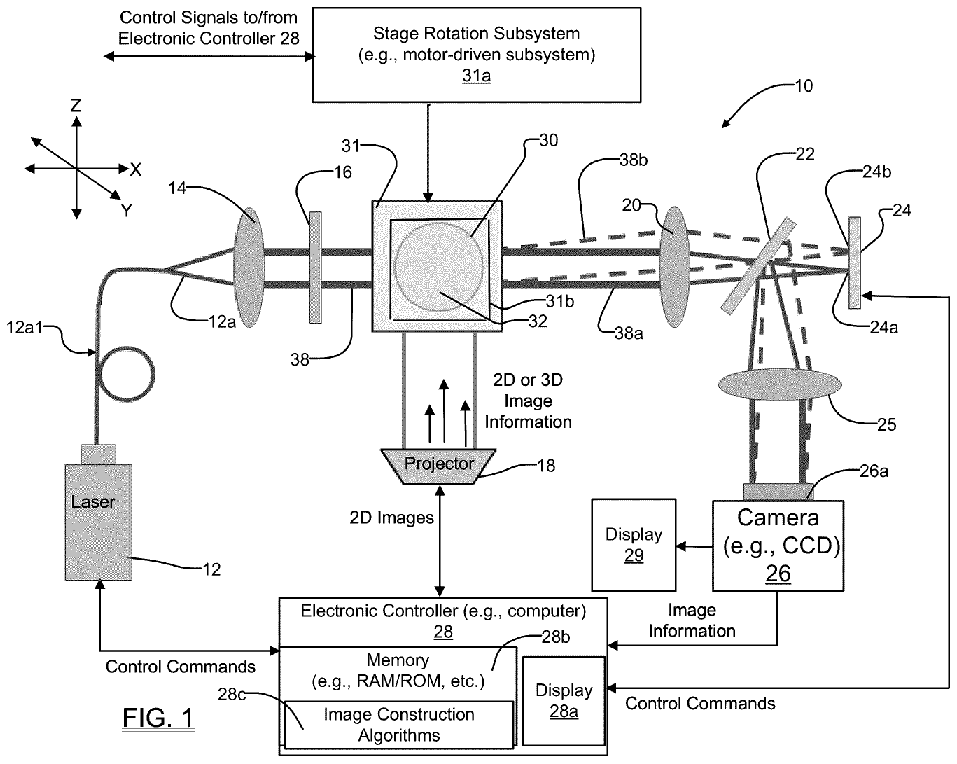

One embodiment of a phase-based optical imaging system 10 for VAM in accordance with the present disclosure is shown in FIG. 1. In this embodiment the system 10 includes a light source, which in this example is a laser 12, a light projector 18, a first lens 14, a polarizer 16, a second lens 20, a beam splitter 22, a spatial light modulator (“SLM”) 24, a third lens 25 and a camera 26.

An electronic controller 28 may be used to control one or more of the laser 12, the projector 18, a rotational stage 31, the SLM 24 and the camera 26. A resin reservoir, in this example a resin vial 30, contains a quantity of photosensitive resin 32. The resin vial 30 in some embodiments may be mounted on the rotational stage 31, which is in turn responsive to a stage rotation subsystem 31a (e.g., motor drive subsystem) for rotating the rotational stage 31 and the resin vial 30 in a highly controlled manner within an X/Y plane. In some embodiments, an optically transparent stationary secondary container 31b is provided in which the resin vial 30 is positioned. The secondary container 31b may be filled with a fluid whose refractive index matches the refractive index of the photo-responsive resin 32. The secondary container 31b is typically of a square shape and remains stationary while the resin vial 30 is sequentially rotated using the rotational stage 31 to different angular positions, where an evolving 2D image is projected from the projector 18 into the photo-responsive resin at each one of the different angular positions. In some embodiments the secondary container 31b is replaced by a negative cylindrical lens (not shown), which is spatially attached to the resin vial 30 with the curvature of the concave surface matching that of the vial, and the projector 18 projects images to the flat surface of the cylindrical lens. In some embodiments there is no secondary container or cylindrical lens. In some embodiments the stage 31 may also be movable along a Z axis as well via the stage rotation subsystem 31 or via a separate motion control subsystem (e.g., motor driven to move the stage 31 along the Z axis). The systems and methods described herein may be carried out in part or supplemented with teachings from U.S. Pat. No. 10,647,061 to Kelly et al., issued May 12, 2020, and assigned to the assignee of the present disclosure, and hereby incorporated by reference into the present disclosure.

In some embodiments the laser 12 may be any light source as long as it creates interference between an un-scattered reference beam and a scattered sample beam, and the wavelength of the light source won't trigger the resin material polymerization. In some embodiments the light source can be a continuous-wave laser (CW laser) or a superluminescent diode (SLD). In some embodiments the projector can be a DLP projector (Digital Light Projector) or any other type of device which can project images. In some embodiments the camera 26 may be a Charge Coupled Display (CCD) camera or a Complementary Metal Oxide Semiconductor (CMOS) camera, or any other type of suitable image recording device.

In operation, the laser 12 generates a beam 12a along an optical fiber 12a1 which leaves the optical fiber and propagates into and through the first lens 14, and then into the polarizer 16 where the light beam is p-polarized by the polarizer. A collimated p-polarized light beam 38 exits the polarizer 16 and is used to illuminate the resin 32 in the resin vial 30. After passing through the resin 32, the p-polarized light beam 38 separates into two beams: an un-scattered reference beam 38a which does not experience a refractive index (RI) change, and which follows the original propagation direction of the p-polarized beam 38; and a scattered sample beam 38b which undergoes a refractive index (“RI”) change from passing through a portion of the resin 32 which has undergone (or is undergoing) polymerization. Accordingly, the scattered sample beam 38b deviates from the original propagation direction of the p-polarized beam 38.

These two light beams 38a and 38b are collected by the second lens 20 and focused onto the spatial light modulator (SLM) 24 after passing through the beam splitter 22. As a result, the un-scattered reference beam 38a will be tightly focused on a central region 24a of the SLM 24, whereas the scattered sample beam 38b will be focused on the surrounding area 24b around the central region 24a. The SLM 24 has the ability to modulate and change the phase distribution of a beam incident thereon. Here the SLM 24 will introduce the phase shift between the un-scattered reference beam 38a and the scattered sample beam 38b. The incident light made up of beams 38a and 38b is reflected by the SLM 24, collected and focused by the third lens 25 on an image sensor 26a of the camera 26, and finally the interference patterns created between the un-scattered reference beam 38a and the scattered sample beam 38b are then recorded on the camera 26. The camera 26 may optionally output this image information to the electronic controller 28, and/or to another controller/computer or analytical component for recording and/or analysis, and/or to an independent display device 29 (e.g., LED or LCD monitor, etc.). Optionally, the electronic controller 28 may include its own display 28a and/or memory 28b for storing image information collected during a polymerization process. The electronic controller memory 28b may also be used to store image analysis/reconstruction phase analysis algorithms 28c needed to help create the phase shifted images and the quantitative phase image, as will be discussed further in the following paragraphs.

### Phase-based Imaging Method 1 (Quantitative Phase Imaging (QPI)

In one embodiment the system 10 implements a quantitative phase imaging (“QPI”) methodology. In one embodiment this methodology is achieved by a common-path phase-shifting interferometry technique: a sequence of two or more phase shifts are used between the un-scattered reference beam 38a and scattered sample beam 38b, which are imparted by the SLM 24. In some embodiments at least two phase shifted images are used to form a composite QPI image. In some embodiments three or four phase shifted images are used to create the composite QPI image. In the following discussion, the example of using four distinct images including one unshifted phase image and three different phase shifted images to form the composite QPI image will be described.

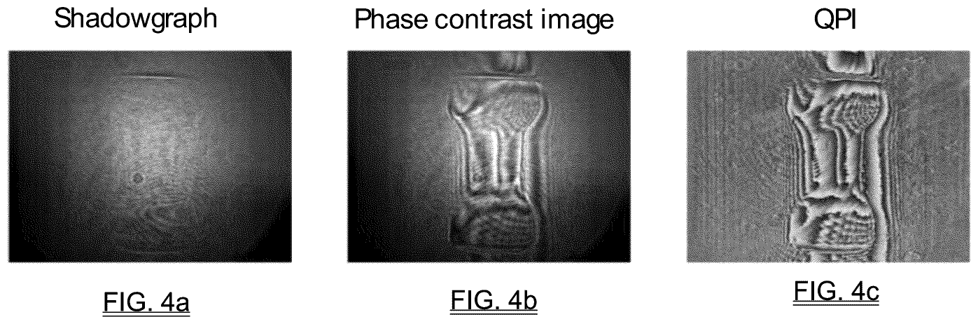

Referring briefly to FIG. 3, the QPI technique is shown in a highly simplified drawing. Area 50 of the photo-responsive resin 32 has a first refractive index, and area 52 has a second refractive index which is higher than that of the area 50. The scattered sample beam 38b and the reference beam 38a will combine to form a hologram 54 on the image sensor of the camera 26. From this hologram one can determine a phase of the light beam passing through the photo-responsive resin 32.

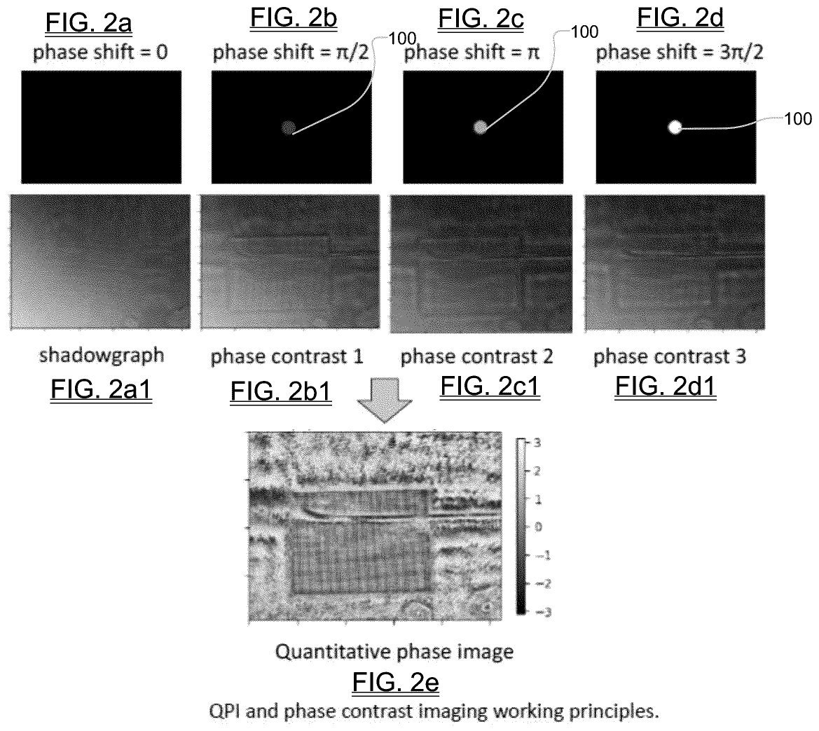

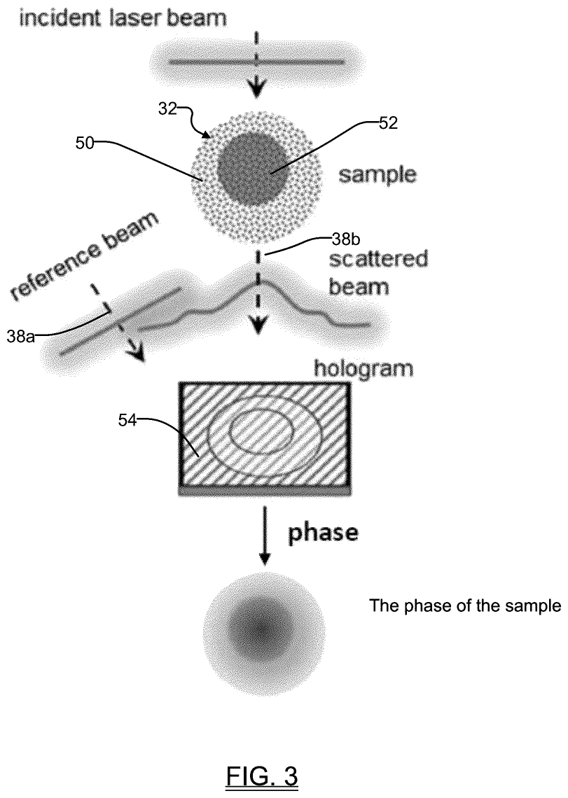

Referring specifically to FIGS. 2a-2d, the phase value of the pixels within a central circle 100 is 0, π/2, π, 3π/2 for four phase shifts (i.e., FIGS. 2a-2d), respectively, and the value of other pixels are constantly 0, as shown in FIGS. 2a-2d. For each phase shift introduced by the SLM 24, a sample image is captured by the camera: a shadowgraph I₀(x, y) is measured when phase shift is 0; Three phase contrast images

$${I}_{\frac{π}{2}} ( x , y ) , {I}_{π} ( x , y ) , {I}_{\frac{3 π}{2}} ( x , y )$$

are measured when phase shifts are π/2, π, 3π/2, respectively.

A quantitative phase image, shown in FIG. 2e, is retrieved from the four raw intensity images:

$$Δφ = arctan ( \frac{{I}_{\frac{π}{2}} ( x , y ) - {I}_{\frac{3 π}{2}} ( x , y )}{{I}_{0} ( x , y ) - {I}_{n} ( x , y )} ) \qquad Eq . ( 1 )$$

The quantitative phase image shown in FIG. 2e is linearly related to the RI change Δn of the resin under polymerization by:

$$Δ n = ( \frac{Δφ}{2 π} ) \cdot \frac{λ}{h} \qquad Eq . ( 2 )$$

where λ is the QPI illumination wavelength and h is the resin thickness with RI change. With the phase, or equivalently the RI change map of the resin volume, one can visualize the VAM polymerization process. Thus, the QPI methodology implemented by the system 10 in this embodiment is a highly sensitive imaging method which provides a high contrast image even for a minute RI change in the resin when polymerization is occurring, or has fully occurred.

### Phase-Based Imaging Method 2: Phase Contrast Imaging

In another embodiment the system 10 implements a phase contrast imaging methodology. By simply shifting the phase of the un-scattered reference beam 38a by π/2, the intensity of phase contrast image 1 (FIG. 2a1) suddenly exhibits much higher contrast than a shadowgraph (FIG. 2a) with no phase shift of the un-scattered reference beam. With the present system 10, phase contrast imaging may also be used to visually monitor the onset and progression of the VAM polymerization process.

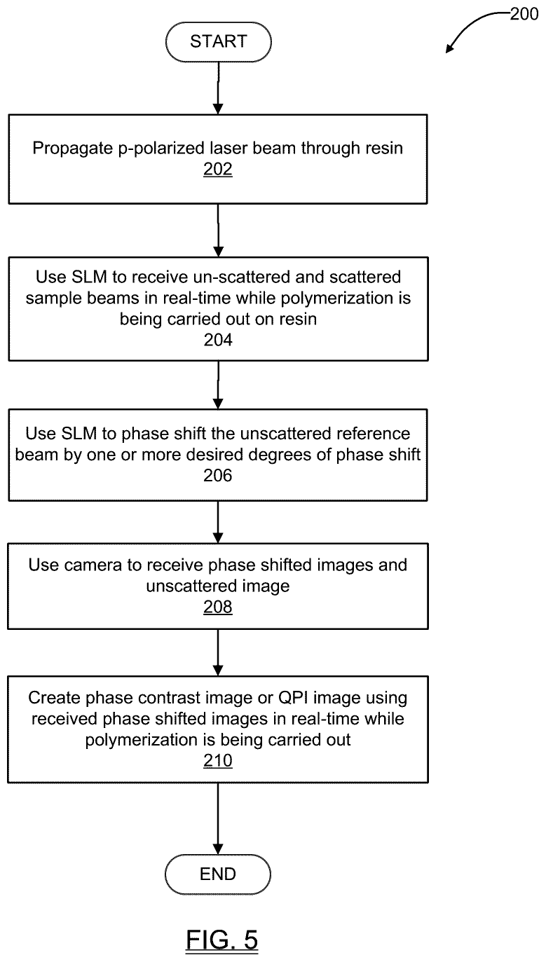

FIGS. 4a-4c illustrate a measured shadowgraph (FIG. 4a), a measured phase contrast image (FIG. 4b), and a reconstructed QPI image (FIG. 4c) during the real-time visualization of a VAM process for a silicone resin material. In this example the silicone resin material has a refractive index change which is small during and after polymerization. These images highlight the dramatically increased contrast and details available in the phase contrast image (FIG. 4b) and QPI image (FIG. 4c) over a shadowgraph (FIG. 4a). FIGS. 4a-4c thus demonstrate the ability and advantage of using phase-based imaging methods to monitor VAM processes with low refractive index change resin materials.

Referring to FIG. 5, a high level flowchart 200 is shown illustrating various operations that may be performed by the system 10 in creating a QPI. Initially a p-polarized beam (e.g., beam 38a in FIG. 1) is propagated through the resin 32, as indicated at operation 202. The SLM 24 is used to receive the un-scattered reference beam and scattered sample beam (e.g., beams 38a and 38b, respectively) in real-time while polymerization is being carried out on the resin, as indicated at operation 204. At operation 206 the SLM is used to phase shift the un-scattered reference beam by one or more desired degrees of phase shift. At operation 208 a camera (e.g., camera 26 in FIG. 1) is used to receive the phase shifted images and the unscattered image. At operation 210 the phase contrast image may be displayed, or alternatively the QPI image may be reconstructed by the electronic controller 28 (or computer) using the received phase shifted images and the unshifted image, in real-time, while polymerization is being carried out, as indicated at operation.

It will be appreciated that the system 10 and the methodology described herein is not limited to using multiple phase shifted images to create a high contrast image of the resin as the polymerization process is being carried out. Essentially any form of detecting a phase change in a light beam being propagated into and through the photo-responsive resin 32 may be used to help create a high contrast image. Other possible phase detection methods that may be used may involve digital holography method, Hilbert phase imaging method, or diffraction phase imaging method, or differential interference contrast (DIC) method.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The system 10 in its various embodiments, along with the above-described methodology, therefore makes it possible to easily visualize a VAM process even when low-RI-change materials are being used to make a part. The system 10 and methodology described herein thus make visualizing the polymerization process possible for low RI change materials, in real-time, such as silicones, organogels, hydrogels, or optical polymers. Silicones have heretofore been especially challenging because of the low RI change they exhibit during polymerization, but the system 10 and methodology is able to produce images in real-time during polymerization with amble detail to visualize the polymerization process occurring.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system for monitoring polymerization of a photo-responsive resin held in a reservoir during an additive manufacturing operation involving manufacture of a part from the photo-responsive resin, the system including:
an optical system for generating a beam of light;
a polarizer for polarizing the beam of light to create a linearly polarized light beam, the linearly polarized light beam forming a first un-scattered beam after passing through a portion of the photo-responsive resin having a first refractive index, and a second scattered sample beam after passing through a second portion of the photo-responsive resin having begun a polymerization process and having a second refractive index;
a spatial slight modulator for receiving the first un-scattered beam and the second scattered sample beam and controllably varying a phase of one of the un-scattered beam or the scattered sample beam to create multiple images of the photo-responsive resin representing a phase shift between the first un-scattered beam and the second scattered sample beam; and
a controller subsystem for receiving and combining the multiple images to create a composite image having increased contrast of the photo-responsive resin.

2. The system of claim 1, further comprising a camera for collecting the multiple images to recording an interference pattern between the first un-scattered beam and the second scattered sample beam.

3. The system of claim 2, further comprising a beam splitter disposed upstream of the spatial light modulator, relative to a path of travel of the first un-scattered beam and the second scattered sample beam, and downstream of the resin reservoir, relative to the path of travel of the first un-scattered beam and the second scattered sample beam, the beam splitter configured to enable portions of each of the first un-scattered beam and the second scattered sample beam to be received by both of the camera and the SLM.

4. The system of claim 3, further comprising:
a first lens disposed upstream of the resin reservoir, relative to a path of travel of the first un-scattered beam and the second scattered sample beam, for focusing the beam of light from the laser on the polarizer; and
a second lens disposed downstream of the resin reservoir, and upstream.

5. The system of claim 1, further comprising a projector, responsive to the controller subsystem, for projecting images representing at least one of 2D or 3D image information into the resin reservoir.

6. The system of claim 1, further comprising a movable stage for rotating the resin reservoir.

7. The system of claim 1, further comprising a rotation subsystem for rotating the resin reservoir.

8. The system of claim 1, wherein the optical system comprises a laser.

9. The system of claim 1, wherein the polarizer comprises a p-polarizer for created a p-polarized further comprising a polarizer configured to create the linearly polarized light beam from the beam of light.

10. A system for monitoring polymerization of a photo-responsive resin held in a reservoir during an additive manufacturing operation involving manufacture of a part from the photo-responsive resin, the system including:
a spatial light modulator;
a camera;
a laser for generating a beam of light;
a projector for projecting at least one of a 2D or 3D image into the resin held within the reservoir, the 2D or 3D image representing the part;
a polarizer for polarizing the beam of light to create a linearly polarized light beam, the linearly polarized light beam forming a first un-scattered beam after passing through a portion of the photo-responsive resin having a first refractive index, and a second scattered sample beam after passing through a second portion of the photo-responsive resin having begun a polymerization process and having a second refractive index;
a beam splitter for passing a first portion of the first un-scattered beam and a first portion of the scattered sample beam to the spatial light modulator, and a second portion of the first un-scattered beam and a second portion of the second scattered sample beam to the camera for recording as images representing an interference pattern;
the spatial slight modulator for receiving the first portion of the first un-scattered beam and the first portion of the second scattered sample beam and controllably varying a phase of one of the un-scattered beam or the scattered sample beam to create at least one image of the photo-responsive resin representing a phase shift between the first un-scattered beam and the second scattered sample beam, and transmitting image information corresponding to the phase shift back through the beam splitter to the camera; and
a controller subsystem for receiving and combining the second portion of the un-scattered beam and the image information to create a composite image having increased contrast of the photo-responsive resin.

11. The system of claim 10, wherein the camera is used to at least one of record or display images of the un-scattered beam and the image information corresponding to the phase shift.

12. The system of claim 10, wherein the laser comprises a continuous wave laser.

13. The system of claim 10, further comprising a lens upstream of the camera and downstream of the beam splitter, relative to a path of travel of the un-scattered beam, for focusing the image information and the un-scattered beam on the camera.

14. The system of claim 10, further comprising a stage rotation subsystem for supporting the resin reservoir and rotating the resin reservoir relative to the spatial light modulator.

15. The system of claim 10, wherein the camera comprises a charge coupled display (CCD).

16. The system of claim 10, further comprising:
a first lens upstream of the resin reservoir relative to a path of travel of the beam of light from the laser, for focusing the beam of light on the polarizer; and
a second lens upstream of the beam splitter and downstream of the resin reservoir, relative to the path of travel of the first un-scattered beam, for focusing the first un-scattered beam and the second scattered sample beam on the beam splitter.

17. A method for monitoring polymerization of a photo-responsive resin held in a reservoir during an additive manufacturing operation involving manufacture of a part from the photo-responsive resin, the method including:
generating a beam of light;
using a polarizer to polarize the beam of light to create a linearly polarized light beam, the linearly polarized light beam forming a first un-scattered beam after passing through a portion of the photo-responsive resin having a first refractive index, and a second scattered sample beam after passing through a second portion of the photo-responsive resin having begun a polymerization process and having a second refractive index;
using the first un-scattered beam and the second scattered sample beam to controllably varying a phase of one of the un-scattered beam or the scattered sample beam to create multiple images of the photo-responsive resin representing a phase shift between the first un-scattered beam and the second scattered sample beam; and
combining the multiple images to create a composite image having increased contrast of the photo-responsive resin.

18. The method of claim 17, further comprising using a camera to receive the multiple images and record the multiple images.
